(19) United States
(12) Patent Application Publication
(10) Pub. No.: US 2025/0350185 A1
(43) Pub. Date: Nov. 13, 2025

(54) HYBRID SWITCHED CAPACITOR CONVERTER WITH FLYING CAPACITOR

(71) Applicant: Infineon Technologies Austria AG, Villach (AT)

(72) Inventors: Roberto RIZZOLATTI, Villach (AT); Mario URSINO, Villach (AT); Matthias J. Kasper, Villach (AT)

(21) Appl. No.: 18/658,785

(22) Filed: May 8, 2024

(51) Int. Cl. H02M 1/00; H02M 3/07

(52) U.S. Cl. CPC H02M 1/0095; H02M 3/07

(57) ABSTRACT

An apparatus such as a power converter includes: a first circuit path including first windings coupled in series, each of the first windings magnetically coupled to each other; a second circuit path including second windings coupled in series, each of the second windings magnetically coupled to each other; and switch circuitry operative to selectively switch between electrically connecting a flying capacitor in series with the first circuit path and electrically connecting the flying capacitor in series with the second circuit path. A controller controls the switch circuitry in the power converter to convert an input voltage into an output voltage.

### BACKGROUND

Data centers such as operated by Google™, Facebook™, and others provide indispensable services for our society. The energy consumption for all data centers worldwide is around 2% of overall electric energy usage. Therefore, datacenter providers are constantly looking to improve the efficiency of power conversion in order to save energy or to be able to increase the CPU/GPU/ASIC, etc., power of servers in existing data centers. Machine learning and artificial intelligent architectures require very powerful GPUs or custom designed ASICs to meet the required calculation power.

Traditionally, data center equipment operates with a 48 VDC input voltage, or alternatively, with a variable input voltage ranging from 40 VDC to 60 VDC, rather than the common 12 VDC bus. This preference for higher DC voltages offers several advantages, including reduced distribution losses within the server rack and motherboard. Various conventional methods are employed to deliver higher power per rack and per board, often involving the conversion of the input voltage into one or more output voltages.

It is noted that data center equipment, or other electronics in general, may include conventional Zero Voltage Switching Switched Capacitor (ZSC) converters. Such converters may be based on the Dickson charge pump. In such an instance, a ratio of the input voltage to the output voltage may be given by the number of switched capacitors cells employed in the circuit. Such converter offers high performance for 2:1 and 4:1 operation, due to resonant operation and soft switching operation, however, such converter is a preferable solution when a “down-solution” is required. Further, such conventional converters are controlling the increase of power with the use of lower on-resistance power switches, however, at PCB level the current density will follow the current path forced by the field effect transistor position and won't spread as in a transformer-based solution.

Another type of conventional power converter is based on implementation of higher step-down ratios where a transformer-based solution is preferable, as it provides an easy way to increase the transfer ratio by adjusting the transformer turn ratio. A so-called DCX (“DC-Transformer”) power converter is essentially an LLC converter operated with a fixed switching frequency at the resonance frequency. At this operating point, the gain-factor of the resonant tank is equal to 1. Since the DCX is not varying the switching frequency to adjust the gain-factor like in the LLC, it is typically enough to use the parasitic leakage inductance of the transformer as resonant inductor. Thus, the magnetic element in the DCX does not saturate with higher load currents. Furthermore, the magnetizing current can be used to achieve soft-switching (ZVS) over the entire load range, i.e. independent of the load. The amount of magnetizing current can be easily adjusted by changing the magnetizing inductance, e.g. by adjusting the air-gap.

### BRIEF DESCRIPTION

Implementation of clean energy (or green technology) is very important to reduce our impact as humans on the environment. In general, clean energy includes any evolving methods and materials to reduce an overall toxicity on the environment from energy consumption.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, wireless base stations, etc. In certain instances, energy is stored in a respective one or more battery resource. Alternatively, energy is received from a voltage generator. Regardless of whether energy is received from green energy sources or non-green energy sources, it is desirable to make most efficient use of raw energy (such as storage and subsequent distribution) provided by such systems to reduce our impact on the environment. This disclosure contributes to reducing our carbon footprint and better use of energy via more efficient energy conversion.

This disclosure further includes the observation that power conversion efficiency and/or density of conventional power supplies can be improved. For example, to this end, this disclosure includes novel ways of providing improved performance and density (such as smaller circuits providing more power) of power conversion via balanced generation of current in different legs of a respective power converter.

More specifically, this disclosure includes an apparatus (such as power converter, power converter stage, etc.) comprising: a first circuit path including first windings coupled in series, each of the first windings magnetically coupled to each other; a second circuit path including second windings coupled in series, each of the second windings magnetically coupled to each other; and switch circuitry operative to selectively switch between electrically connecting a flying capacitor in series with the first circuit path and electrically connecting the flying capacitor in series with the second circuit path.

In accordance with further examples, the apparatus as discussed herein includes an output node operative to: i) receive a first output current from a first tap node of the first windings and a second output current from a second tap node of the second windings, and ii) output a combination of the first output current and the second output current from the output node to power a load.

In still further examples, the first windings may include a first winding and a second winding; the first winding and the second winding may be disposed in series in a first autotransformer winding path of an autotransformer; the second windings may include a third winding and a fourth winding; the third winding and the fourth winding may be disposed in series in a second autotransformer winding path of the autotransformer; and the first windings and the second windings may be magnetically coupled to each other. In other words, the first windings in the second windings may be disposed in a single autotransformer.

Still further, the first windings may be disposed in a first autotransformer; the second windings may be disposed in a second autotransformer, the second autotransformer may be magnetically independent from the first autotransformer. In other words, the second autotransformer is magnetically separated from the first autotransformer. Thus, the power converter as discussed herein can be configured to include multiple autotransformers.

In accordance with further examples as discussed herein, the apparatus may further include a first capacitor; a second capacitor. The first circuit path may be a first resonant circuit path including the first capacitor disposed in series with the first windings; the second circuit path may be a second resonant circuit path including the second capacitor disposed in series with the second windings.

Yet further, the switch circuitry as discussed herein may include a first switch (Q2) and a second switch (Q3). The apparatus may further include a controller operative to switch between a first mode and a second mode of controlling the first switch and the second switch. The first mode may include activation of the second switch to an ON-state and deactivation of the first switch to an OFF-state; and the second mode may include activation of the first switch to an ON-state and deactivation of the second switch to an OFF-state. The activation of the second switch in the first mode is operative to electrically connect a first node of the flying capacitor to the second circuit path; and the deactivation of the second switch in the first mode is operative to electrically disconnect the first node of the flying capacitor from the first circuit path.

Still further, the first circuit path can be configured to include a first capacitor disposed in series with the first windings; the second circuit path can be configured to include a second capacitor disposed in series with the second windings. The switch circuitry can be configured to include a third switch (Q4) directly coupled to the second switch (Q3); wherein activation of the first switch (Q2) in the second mode is operative to produce a first circuit loop including the first capacitor, the first windings, and the flying capacitor in series; and wherein activation of the third switch (Q4) producing a second circuit loop including the second capacitor and the second windings in series.

In yet further examples as discussed herein, the first windings and the second windings are disposed in a multi-tapped autotransformer; and the first windings and the second windings are magnetically coupled to each other in the multi-tapped autotransformer.

Another example as discussed herein includes first switch circuitry (Q5) directly coupled to a first tap node (PH1) of the first windings; second switch circuitry (Q7) directly coupled to a first tap node (PH2) of the second windings. The apparatus or system as discussed herein can be configured to include a controller operative to switch between operation of the first switch circuitry and the second switch circuitry in a first mode and a second mode. In such an instance, the first mode includes deactivation of the first switch circuitry to an off state and deactivation of the second switch circuitry to an off state; and the second mode includes activation of the first switch circuitry to an on state and activation of the second switch circuitry to an on state. The first windings may include a second tap node; the second windings may include a second tap node. The apparatus may further include an output node operative to receive first output current outputted from the second tap node of the first windings and a second output current outputted from the second tap node of the second windings.

Still further, the apparatus may include: a first capacitor disposed in series with the first windings in the first circuit path, and a second capacitor disposed in series with the second windings in the second circuit path. The controller can be configured to control the switch circuitry in accordance with a first mode, the control of the switch circuitry in the first mode may be operative to cause: i) a first flow of current from an input voltage source through the first circuit path to a reference voltage, and ii) a second flow of current through a combination of the flying capacitor and the second circuit path to the reference voltage.

In a further example, the first flow of current is first resonant current through the first circuit path; and the second flow of current is second resonant current through the second circuit path, the second flow of current through the second circuit path operative to charge the flying capacitor.

In another example, the controller is further operative to control the switch circuitry coupled to the first circuit path and the second circuit path in accordance with a second mode, the control of the switch circuitry in the second mode may be operative to: i) electrically connect the first capacitor and the flying capacitor in series to create a first circuit loop including a combination of the first circuit path and the flying capacitor, and ii) electrically connect a node of the second capacitor to a node of the second windings to create a second circuit loop.

Still further examples as discussed herein include an apparatus comprising: a first circuit path including a series combination of a first capacitor and first inductive windings, the first inductive windings operative to output a first output current; a second circuit path including a series combination of a second capacitor and second inductive windings, the second inductive windings operative to output a second output current; and a controller operative to control switch circuitry in a first mode and a second mode, the first mode including activation of a first switch (Q3) of the switch circuitry to an on state to electrically couple a first node of a flying capacitor to the second circuit path, the second mode including activation of a second switch (Q2) of the switch circuitry to an on state to electrically couple the first node of the flying capacitor to the first circuit path.

In accordance with a further example, the first inductive windings and the second inductive windings are inductively coupled to each other in a multi-tapped autotransformer.

The first inductive windings may be disposed in a first autotransformer; the second inductive windings may be disposed in a second autotransformer. Alternatively, the first inductive windings and the second inductive windings may be disposed in a single autotransformer.

Note further that the switch circuitry as discussed herein may include a third switch (Q6) directly coupled to a second node of the flying capacitor. The controller may be configured to activate the third switch to an on state during the first mode; the controller may be configured to deactivate the third switch to an off state during the second mode.

Further examples as discussed herein include a method comprising: controlling switch circuitry in accordance with a first mode and a second mode, the switch circuitry disposed in a power converter including a first circuit path and a second circuit path; wherein the first circuit path includes first windings coupled in series, each of the first windings magnetically coupled to each other; wherein the second circuit path includes second windings coupled in series, each of the second windings magnetically coupled to each other; wherein controlling switch circuitry in the first mode includes activating a second switch (Q3) of the switch circuitry to an on state to electrically couple a first node of a flying capacitor to the second circuit path; and wherein controlling the switch circuitry in the second mode includes activating a first switch (Q2) of the switch circuitry to an on state to electrically couple the first node of the flying capacitor to the first circuit path.

Note that this disclosure includes useful techniques. For example, in contrast to conventional techniques, the novel power supply as described herein provides high efficiency of converting an input voltage to a respective output voltage.

Note that any of the resources as discussed herein can include one or more computerized devices, apparatus, hardware, etc., execute and/or support any or all of the method operations disclosed herein. In other words, one or more computerized devices or processors can be programmed and/or configured to operate as explained herein to carry out the different techniques as described herein.

Other aspects of the present disclosure include software programs and/or respective hardware to perform any of the operations summarized above and disclosed in detail below.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of techniques herein (BRIEF DESCRIPTION) purposefully does not specify every novel aspect of the present disclosure or claimed invention(s). Instead, this brief description only presents general aspects and corresponding points of novelty over conventional techniques. For additional details and/or possible perspectives (permutations) of the invention(s), the reader is directed to the Detailed Description section (which is a summary) and corresponding figures of the present disclosure as further discussed below.

### BRIEF DESCRIPTION OF THE DRAWINGS

FIG. 1 is an example diagram illustrating a power converter including a respective flying capacitor disposed between multiple switched circuit paths as discussed herein.

FIG. 2 is an example diagram illustrating multiple multi-tapped autotransformers implemented separately for use in a power converter as discussed herein.

FIG. 3 is an example diagram illustrating a single multi-tapped autotransformer for use in a power converter as discussed herein.

FIG. 4 is an example timing diagram illustrating control of a respective switches of a power converter to convert an input voltage into an output voltage as discussed herein.

FIG. 5 is an example diagram illustrating operation of the hybrid switched capacitor power converter during a first mode as discussed herein.

FIG. 6 is an example diagram illustrating operation of the hybrid switched capacitor power converter during a dead time mode as discussed herein.

FIG. 7 is an example diagram illustrating operation of the hybrid switched capacitor power converter during a second mode as discussed herein.

FIG. 8 is an example diagram illustrating a hybrid switched capacitor power converter as discussed herein.

FIG. 9 is an example diagram illustrating implementation of a controller via computer processing hardware as discussed herein.

FIG. 10 is an example diagram illustrating a general method of operating a power converter as described herein.

The foregoing and other objects, features, and advantages of the disclosed matter herein will be apparent from the following more particular description herein, as illustrated in the accompanying drawings in which like reference characters refer to the same parts throughout the different views. The drawings are not necessarily to scale, with emphasis instead being placed upon illustrating the principles, concepts, aspects, techniques, etc.

### DETAILED DESCRIPTION

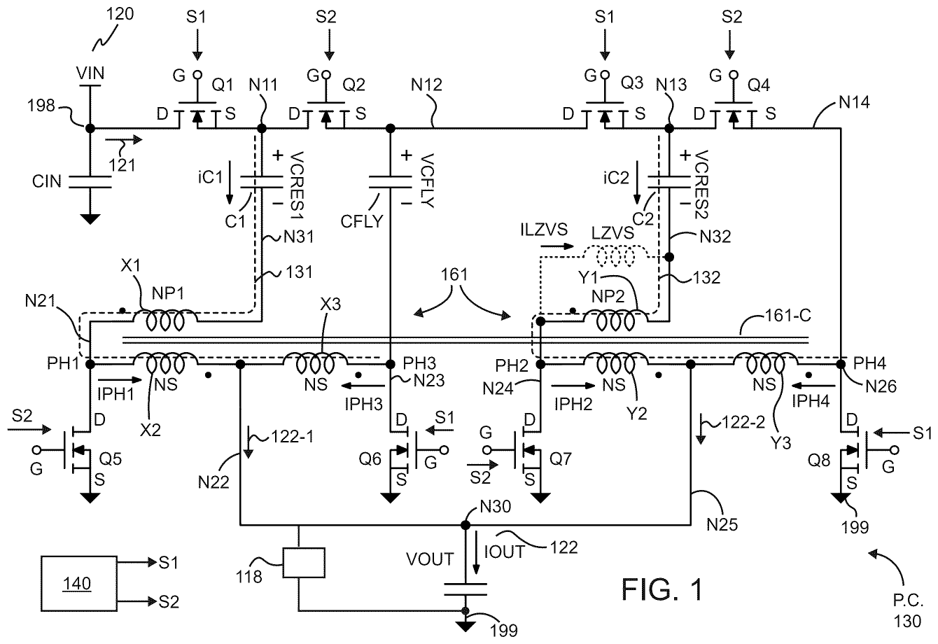

Now, more specifically, FIG. 1 is an example diagram illustrating a novel power converter (such as DC-DC power converter) to convert an input voltage into an output voltage as discussed herein.

As shown in FIG. 1, power supply 100 includes a controller 140 and power converter 130 to receive the input voltage 121 from the voltage source 120. In general, the controller 140 controls the power converter 130 and switching of corresponding circuit paths to convert the received input voltage 121 into an output voltage 123 and corresponding output current 122 (a.k.a., iout) to power a load 118.

The power converter 130 as shown in FIG. 1 can be configured to include any suitable circuitry to support conversion of the input voltage 121 into the output voltage 123. For example, as shown in FIG. 1, the power converter 130 can be configured to include multiple switches (such as field effect transistors or other suitable switch components) such as switch Q1, switch Q2, switch Q3, switch Q4, switch Q5, switch Q6, switch Q7, and switch Q8.

In this example, the combination of switches Q1, Q2, Q3, Q4, and switch Q8 are connected in series between the input voltage node 198 receiving the input voltage 121 (from power source 120) and the reference node 199 connected to a ground reference voltage of the power source 120.

For example, the drain node D of the switch Q1 is directly connected to the node 198; the source node S of the switch Q1 and the drain node D of the switch Q2 are directly connected to the node N11; the source node S of the switch Q2 and the drain node D of the switch Q3 are directly connected the node N12; the source node S of the switch Q3 and the drain node D of the switch Q4 are directly connected to the node N13; the source node S of the switch Q4 is directly connected to the drain node D of the switch Q8 at node N26; the source node S of switch Q8 is directly connected to the reference voltage node 199.

Additionally, the power converter 130 as discussed herein includes capacitor C1, capacitor C2, capacitor CFLY, capacitor Cout, and a respective transformer assembly 161.

In this example, the series combination of the capacitor C1 (a.k.a., capacitor CRES1) and the winding X1 are connected between node N11 and node N21. The flying capacitor CFLY is connected between the node N12 and the node N23. The series combination of the capacitor C2 (a.k.a., capacitor CRES2) and the winding Y1 are connected between node N13 and node N24.

As further discussed herein, the transformer assembly 161 can be implemented as a single transformer having a single magnetic core or multiple transformers having different magnetic cores.

In this example, assume that the transformer assembly 161 such as one or more autotransformers 161 includes multiple windings such as transformer winding X1, transformer winding X2, transformer winding X3, transformer winding Y1, transformer winding Y2, and transformer winding Y3.

Further in this example, each of the windings in the transformer assembly 161 can be wound or is wrapped around a common magnetic core 161-C such that each of the windings in the transformer assembly 161 is magnetically coupled to each other.

For example, a first sequence of series windings includes winding X1, winding X2, and winding X3 wrapped around the magnetic core 161-C and disposed in series between node N31 and node N23. Node N21 represents a first tap node of the transformer 161; node N22 represents a second tap node of the transformer 161.

A second sequence of series windings includes winding Y1, winding Y2, and winding Y3 wrapped around the magnetic core 161-C and disposed in series between node N32 and node N26. Node N24 represents a third tap node of the transformer 161; node N25 represents a fourth tap node of the transformer 161.

Each of the windings in the transformer 161 can include any number of turns. For example, the transformer winding X1 (primary winding) can be configured to include Np1 turns around the magnetic core 161-C; the transformer winding X2 (secondary winding) can be configured to include Ns turns around the magnetic core 161-C; the transformer winding X3 (secondary winding) can be configured to include Ns turns around the magnetic core 161-C.

The transformer winding Y1 (primary winding) can be configured to include Np2 turns around the magnetic core 161-C; the transformer winding Y2 (secondary winding) can be configured to include Ns turns around the magnetic core 161-C; the transformer winding Y3 (secondary winding) can be configured to include Ns turns around the magnetic core 161-C.

Note that the values Np1, Np2, Ns, etc., can be any suitable magnitude.

In general, as previously discussed, the power converter 130 in this example receives the input voltage 121 supplied by the power source 120. The controller 140 produces respective control signals such as signal S1 and signal S2 to control the respective switches Q1-Q8 in the power converter 130 to convert the input voltage 121 into the corresponding output voltage 123.

The control signal S1 controls operation of switch Q1, switch Q3, switch Q6, and switch Q8. The control signal S2 controls operation of switch Q2, switch Q4, switch Q5, and switch Q7.

Note that each of these components represents an entity such as an apparatus, electronic device, electronic circuitry, etc. Note further that each of the resources as described herein can be instantiated in any suitable manner. For example, the controller 140 can be instantiated as or include hardware (such as circuitry), software (executable instructions), or a combination of hardware and software resources where applicable.

As further shown, the power converter 130 includes a first circuit path 131 and the second circuit path 132.

The first circuit path 131 in this example extends between the node N11 and the node N23. The first circuit path 131 includes a series connection of the capacitor C1, winding X1, winding X2, and winding X3.

The second circuit path 132 extends between the node N13 and the node N26. The second circuit path 132 includes a series connection of capacitor C2, winding Y1, winding Y2, and winding Y3. As previously discussed, the controller 140 generates the control signals S1 and S2.

Via driving the respective nodes (G) of switches Q1, Q3, Q6, and Q8, the control signal S1 controls operation/states of switch Q1, switch Q3, switch Q6, and switch Q8.

Via driving the respective nodes (G) of switches Q2, Q4, Q5, and Q7, the control signal S2 controls operation/states of switch Q2, switch Q4, switch Q5, and switch Q7.

The controller 140 controls switch circuitry (such as switches Q1 through Q8) in accordance with a first mode and a second mode.

As previously discussed, the first circuit path 131 includes first windings such as a combination of winding X1, winding X2, and winding X3 coupled/coupled in series. As previously discussed, each of the first windings X1, X2, X3 is magnetically coupled to each other via the magnetic core 161-C.

The second circuit path 132 includes a series connection of second windings such as windings Y1, Y2, and Y3. As previously discussed, each of the second windings in the circuit path 132 is magnetically coupled to each other via the magnetic core 161-C.

As further discussed herein, the controller 140 controls switch circuitry of the power converter 130 in the first mode such as by activating at least switch Q3 of the switch circuitry to an on state to electrically couple a node N12 of a flying capacitor CFLY to the second circuit path 130-2. The controller 140 also controls the switch circuitry of the power converter 130 in the second mode which includes activating a first switch Q2 to an on state to electrically couple the first node N12 of the flying capacitor to the first circuit path 131. Additional details of controlling the respective switches in the different modes is further discussed below.

Thus, examples herein include an apparatus such as power converter 130 or other suitable entity comprising: a first circuit path 131 including first windings X1, X2, and X3, coupled in series, each of the first windings magnetically coupled to each other; a second circuit path 132 including second windings Y1, Y2, Y3, coupled in series, each of the second windings magnetically coupled to each other; and switch circuitry (such as at least switch Q2 and switch Q3) operative to selectively switch between electrically connecting a flying capacitor CFLY in series with the first circuit path 113 and electrically connecting the flying capacitor in series with the second circuit path 132.

In accordance with further examples, as previously discussed, the power converter 130 as discussed herein can be configured to include capacitor C1 and capacitor C2. The first circuit path 131 or a portion thereof may be a first resonant circuit path including the first capacitor C1 disposed in series with the first windings; the second circuit path 132 or a portion thereof may be a second resonant circuit path including the second capacitor C2 disposed in series with the second windings.

In still further examples, an apparatus as discussed herein includes: a first circuit path 131 including a series combination of a first capacitor C1 and first inductive windings (such as one or more of windings X1, X2, and X3). The first inductive windings output a first output current 122-1 (iPH1+iPH3); a second circuit path 132 including a series combination of a second capacitor C2 and second inductive windings (such as one or more of windings Y1, Y2, and Y3), the second inductive windings are operative to output a second output current 122-2 (such as iPH2+iPH4); and a controller 140 operative to control switch circuitry Q1-Q8 in a first mode and a second mode.

As previously discussed, the first mode of operating a power converter 130 can be configured to include activation of a first switch (Q3) of the switch circuitry to an on state to electrically couple a first node N12 of a flying capacitor CFLY to the second circuit path 132; the second mode includes activation of a second switch (Q2) of the switch circuitry to an on state to electrically couple the first node N12 of the flying capacitor CFLY to the first circuit path 131.

Note further that the switch circuitry as discussed herein includes switch Q6 directly coupled to a second node N23 of the flying capacitor CFLY; the controller 140 activates the switch Q6 to an on state during the first mode; the controller 140 deactivates the switch Q6 to an off state during the second mode.

As shown in FIG. 1, power supply 100 includes a controller 140 and power converter 130 to produce an output voltage 123 to power a load 118. Each of these components represents an entity such as an apparatus, electronic device, electronic circuitry, etc.

Note further that each of the resources as described herein can be instantiated in any suitable manner. For example, the controller 140 can be instantiated as or include hardware (such as circuitry), software (executable instructions), or a combination of hardware and software resources where applicable.

Further, as previously discussed, the proposed power converter 130 such as a Hybrid Switched Capacitor converter with High Ratio (HR-HSC) can be configured to include a row of switches (such as switches Q1 to Q4) which enable an equivalent series connection of two HSC blocks. Each HSC block “x” (x=1 or x=2) has an autotransformer with primary windings Npx (such as Np1 and Np2) and secondary windings Ns. In one example, the secondary windings (such as winding X2, winding X3, winding Y2, winding Y3) are identical, i.e., they may have the same number of turns, therefore no distinction is made; two switches for rectification such as pair of switches including switch Q5 and switch Q6 or combination of switches including switch Q7 and switch Q8 and a corresponding resonant capacitor Cresx (such as capacitor C1 or capacitor C2). In one example, the equivalent series connection is obtained through the flying capacitor CFLY (storing voltage VCfly).

The example power converter 130 as discussed herein includes operating the duty cycle of controlling the respective control signals S1 and S2 at approximately a 50 percent duty cycle.

Note that a magnitude of the output voltage 123 outputted from the node N30 to power the dynamic load 118 depends on the respective multi-tapped autotransformers turns ratios Npx and Ns associated with the transformer 161. Basically, in one example, the total conversion ratio M is just the multiplication of the two conversion ratios.

$$Vin / Vout = [ 4 + 2 Np 1 / Ns ] + [ 4 + 2 Np 2 / Ns ] \qquad equation 1$$

For example, a half-turn can be used for both primaries (Np1=Np2=0.5) with a single turn for every secondary winding (Ns=1) to obtain a total conversion ratio of 10:1.

According to this, the proposed power converter 130 such as HR-HSC is scalable itself to different conversion ratios by designing only the ratio between Npx and Nsx which actually leads to claim a new family of unregulated hybrid dc-dc converter with different ratio (i.e. 10 to 1, 11 to 1, 12 to 1, 13 to 1 . . . ).

One implementation of the power converter 130 as discussed herein includes taking advantage of the leakage inductance Lzvs of the transformer 161 (such as a multi-tapped autotransformer and stored energy) to soft charge the flying capacitors C1 and C2 (a.k.a., Cres1 and Cres2), which are actually acting as flying capacitors themselves, enabling implementation of lower voltage related MOSFET at input side (i.e., switches Q1, Q2, Q3 and Q4) compared to, for example, a classic LLC topology. In this example, switches Q1, Q2, Q3 and Q4 block a portion of the input voltage 121 supplied by the input voltage source 120.

Due to center-tapped rectifier, the actual rectifier MOSFETs (switch pair Q5 and Q6 as well as switch pair Q7 and Q8) have to block 2 times a magnitude of the output voltage 123 (Vout). However, one benefit provided by the power converter 130 is the lower RMS (Root Mean Squares) in both SR FETs (synchronous rectifier field effect transistors).

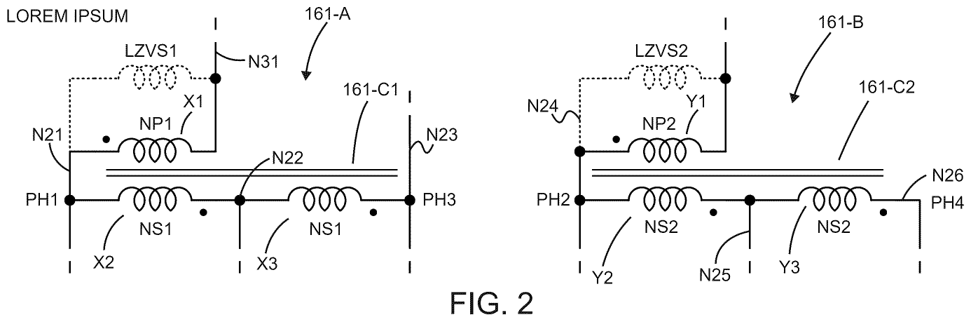

FIG. 2 is an example diagram illustrating implementation of multiple transformer assemblies for inclusion in a power converter as discussed herein.

As previously discussed, note that the transformer assembly 161 can be configured to include multiple transformers including transformer 161-A and transformer 161-B, having two different sets of magnetic cores.

More specifically, the transformer assembly 161 can be configured to include a first transformer 161-A in which the windings X1, X2, X3 are inductively coupled to each other as they are wound in a series manner around the first magnetic core 161-C1.

The transformer assembly 161 can be configured to include a second transformer 161-B in which the windings Y1, Y2, and Y3 are inductively coupled to each other as they are wound in a series manner around the second magnetic core 161-C2. The second magnetic core 161-C2 is independent of the first magnetic core 161-C1. In other words, the second transformer 161-B in FIG. 2 is magnetically separated from the first transformer 161-A because the core 161-C2 is physically separated and independent from the core 161-C1. In such an instance, the windings X1, X2, and X3, are not inductively coupled to the windings Y1, Y2, and Y3.

In this example, the transformer 161-A includes the leakage inductance Lzvs1. Transformer 161-B includes the leakage inductance Lzvs2.

Accordingly, as shown in FIG. 2, the first windings such as windings X1, X2, and X3, may be are disposed in a first autotransformer 161-A; the second windings such as windings Y1, Y2, and Y3 may be disposed in a second autotransformer 161-A. The second transformer 161-B and corresponding magnetic core 161-C2 is magnetically independent from the first autotransformer 161-A and corresponding magnetic core 161-C1.

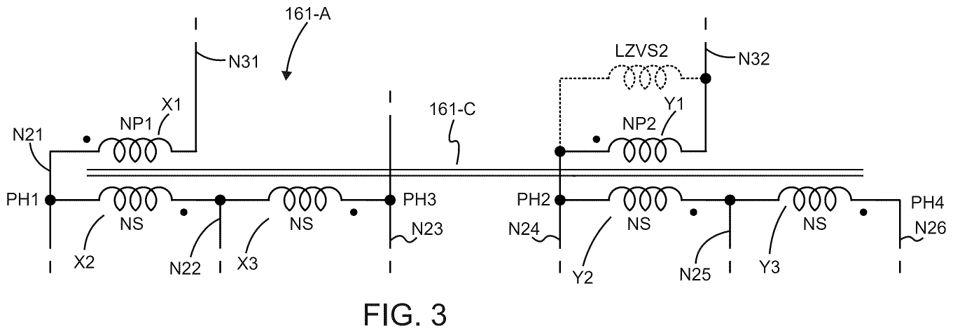

FIG. 3 is an example diagram illustrating implementation of a single transformer assembly for inclusion in the power converter as discussed herein.

As previously discussed, note that the transformer assembly 161 can be configured as multiple series windings wound around the same magnetic core 161-C.

More specifically, as previously discussed, the transformer assembly 161 can be configured to include a first series connection of windings X1, X2, X3 that are inductively coupled to each other as they are wound around the same magnetic core 161-C.

The transformer assembly 161 can be configured to include a second series connection of windings Y1, Y2, Y3 that are inductively coupled to each other as they are wound around the same magnetic core 161-C as well.

In this example, the transformer assembly 161 includes the leakage inductance Lzvs. Via the common magnetic core 161-C, each of the windings X1, X2, X3, are inductively coupled to each of the windings Y1, Y2, Y3.

Referring again to FIG. 1, note that the power converter 130 can be configured as a 6-winding device, where primary windings Npx (such as winding X1 and winding Y1) and secondary windings Nsx (such as winding X2, winding X3, winding Y2, winding Y3, etc.) can be identified, where N is the corresponding number of turns.

In one example, the magnetic device (such as transformer assembly 161) is the merger of two autotransformers: FIG. 2 shows an implementation with two separated autotransformers, which can be combined into a single one, as shown in FIG. 3, if the secondary turns are the same (Ns1=Ns2=Ns). The use of the combined transformer assembly 161 may be useful if high power density is desired.

To understand why high power density is possible, one can just consider the total MMF (Magneto Motive Force) along the winding area of each single autotransformer: this MMF is given by the forced currents (one primary winding and one secondary winding) and the secondary winding connected to ground via the corresponding synchronous rectifier switch SRx. The latter winding is “free” to compensate the enforced MMF by inducing an opposite current. This yields, neglecting the leakage field, a net-zero MMF. Simply stated, if each single autotransformer in the example of FIG. 2 has a net-zero MMF, also the combined structure in FIG. 3 will achieve the same. Moreover, the use of equal secondary turns ensures that each secondary winding experiences the same induced voltage. These considerations enable to change the structure of FIG. 2 to the one of FIG. 3 without changing converter operations, together removing half of the magnetic volume.

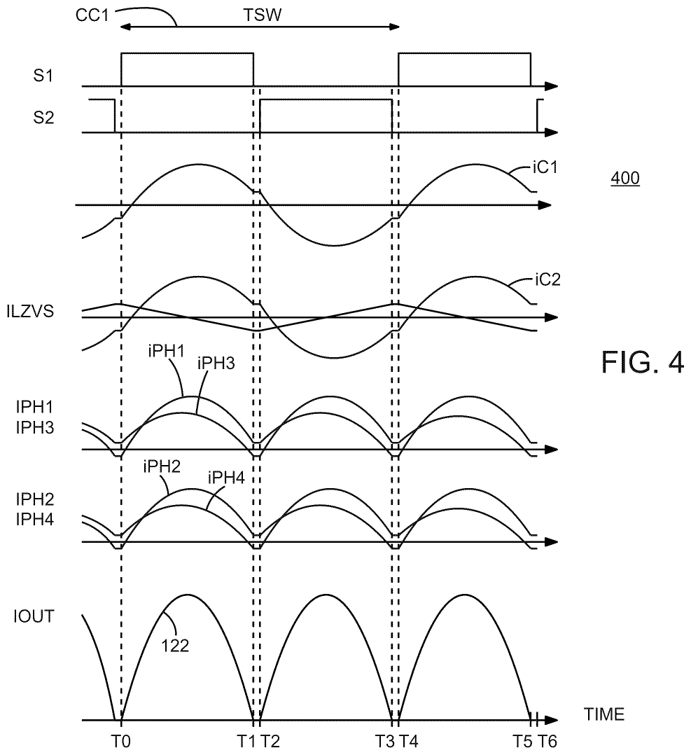

FIG. 4 is an example diagram illustrating operation of the hybrid switched capacitor power converter during a first mode as discussed herein.

Timing diagram 400 in FIG. 4 illustrates voltage levels associated with the control signals S1 and S2 over time (multiple control cycles).

For example, in a first control cycle CC1, between time T0 and time T1, the controller 140 produces the respective control signal S1 to be a logic high; between time T1 and time T4, the controller 140 produces the respective control signal S1 to be a logic low; between time T4 and time T5, the controller 140 produces the respective control signal S1 to be a logic high; and so on.

The controller 140 controls settings of the signal S1 in control cycle CC2 and other subsequent cycles to be similar to or the same as cycle CC1.

Additionally, in control cycle CC1, between time T0 and time T2, the controller 140 produces the respective control signal S2 to be a logic low; between time T2 and time T3, the controller 140 produces the respective control signal S2 to be a logic high; between time T3 and time T6, the controller 140 produces the respective control signal S2 to be a logic low; and so on.

The controller 140 controls settings of the signal S2 in control cycle CC2 and other subsequent control cycles to be similar to or the same as cycle CC1.

Yet further, the timing diagram 400 in FIG. 4 illustrates magnitudes of different currents in the power converter 130 over time.

The current iC1 represents a magnitude of the current through the capacitor C1.

The current iC2 represents a magnitude of the current through the capacitor C2.

The current iLzvs represents a magnitude of the current supplied through the magnetizing inductance Lzvs associated with the transformer 161.

The current iPH1 represents a magnitude of the current supplied through the winding X2 to the node N22 to produce output current 122; the current iPH3 represents a magnitude of the current supplied through the winding X3 to the node N22 to produce the output current 122; the current iPH2 represents a magnitude of the current supplied through the winding Y2 to the node N25 to produce the output current 122; the current iPH4 represents a magnitude of the current supplied through the winding Y3 to produce the output current 122; and so on.

Timing diagram 400 in FIG. 4 further illustrates a magnitude of the output current 122 (iout) supplied from the node N30 to the load 118. For example, the output current 122 (iout) between time T0 and time T1 is equal to current iPH1+iPH2+iPH3+iPH4; the output current 122 (iout) between time T2 and time T3 is equal to current iPH1+iPH2+iPH3+iPH4; and so on.

Between time T1 and time T2 and between time T3 and T4, the magnitude of the output current 122 is substantially zero.

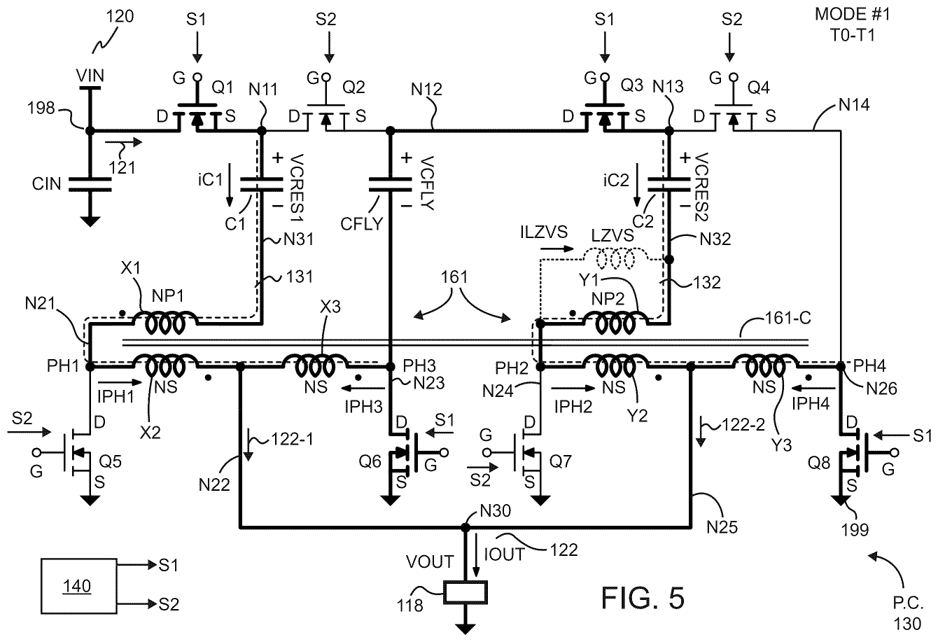

FIG. 5 is an example diagram illustrating operation of the hybrid switched capacitor power converter during a first mode as discussed herein.

During the first mode (mode 1) such as between time T0 and time T1, the controller 140 activates (turns on) the switches Q1, Q3, Q6, and Q8 in accordance with ZVS (zero voltage switching) and in zero current switching (ZCS) and a resonant current takes place between C1 (Cres1) and the leakage inductance Lzvs of the transformer 161 such as a multi-tapped autotransformer, while another resonant current iC2 takes place between capacitor C2 (Cres2) and the leakage inductance Lzvs of the transformer 161. During the first mode (mode 1) such as between time T0 and time T1, the controller 140 deactivates (turns off) the switches Q2, Q4, Q5, and Q7.

In this phase (such as during mode 1 between time T0 and time T1), the capacitor C1 (Cres1) is soft-charged from the input voltage source 120 (Vin) while capacitor C2 such as Cres2 is soft-charged from the flying capacitor CFLY. By assuming iC1(t)=ires(t)=iC2(t) (i.e., cells placed in series through flying capacitor Cfly), the output current 122 can be calculated with the following equation:

$$iout ( t ) = iph 1 ( t ) + iph 3 ( t ) + iph 2 ( t ) + iph 4 ( t ) = i ( res ( t ) ) ( 2 Np 1 / Ns + 2 ) + 〚 2 i 〛 ( res ( t ) ) + i ( res ( t ) ) ( 2 Np 2 / Ns + 2 ) + 〚 2 i 〛 ( res ( t ) ) = i ( res ( t ) ) ( 2 Np 1 / Ns + 2 Np 2 / Ns + 8 ) \qquad equation 2$$

During this phase the following equations are valid (i.e. in steady state):

$$Vin - VCres 1 - Vout Np 1 / Ns - 〚 2 V 〛 out = 0 \qquad equation 3$$

$$VCfly - VCres 2 - Vout Np 2 / Ns - 〚 2 V 〛 out = 0 \qquad equation 4$$

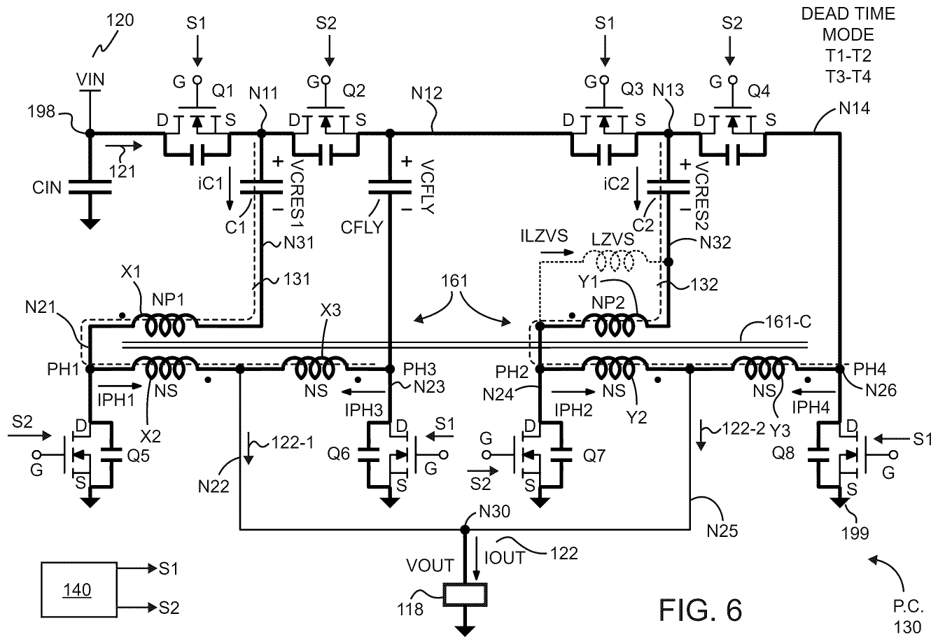

FIG. 6 is an example diagram illustrating operation of the hybrid switched capacitor power converter during a dead time mode as discussed herein.

During the dead time between time T1 and time T2, the controller 140 controls the switches Q1-Q8 to an off state. In such an instance, the parasitic capacitances of switches Q2, Q4, Q5, Q7 are discharged to zero using the inductive energy stored in the Lzvs inductance at time T1. When the parasitic capacitance associated with switches Q2, Q4, Q5, and Q7 are discharged to zero, their corresponding switch body diodes of the respective switches start to conduct to provide ZVS turn on. Note that the current i(Lzvs)(T1) that enables ZVS operation, is denoted as i(L(zvs,pk)) as shown in FIG. 6 which is given by the following equation (i.e. considering Np1=Np2),

$$I ( L ( zvs , pk ) ) = ( Vout Np 2 ) / ( 2 * Lzvs * fsw Ns ) \qquad equation 5$$

In a similar manner, during the dead time between time T3 and time T4, the controller 140 controls the switches Q1-Q8 to an off state, which includes controlling the switches Q1, Q3, Q6, and Q8 to an off state. In response to the turnoff of the switches, the parasitic capacitances of Q1, Q3, Q6, and Q8 (capacitance between a drain node D and the source node S) are discharged to zero, using the inductive energy stored in the Lzvs inductance at t=T3. When the parasitic capacitances of the respective switches Q1, Q3, Q6, and Q8 discharged to zero, their body diodes start to conduct to enable ZVS turn on and the cycle starts again. The current i(Lzvs)(T3) that enables ZVS operation is −i(L(zvs,pk)).

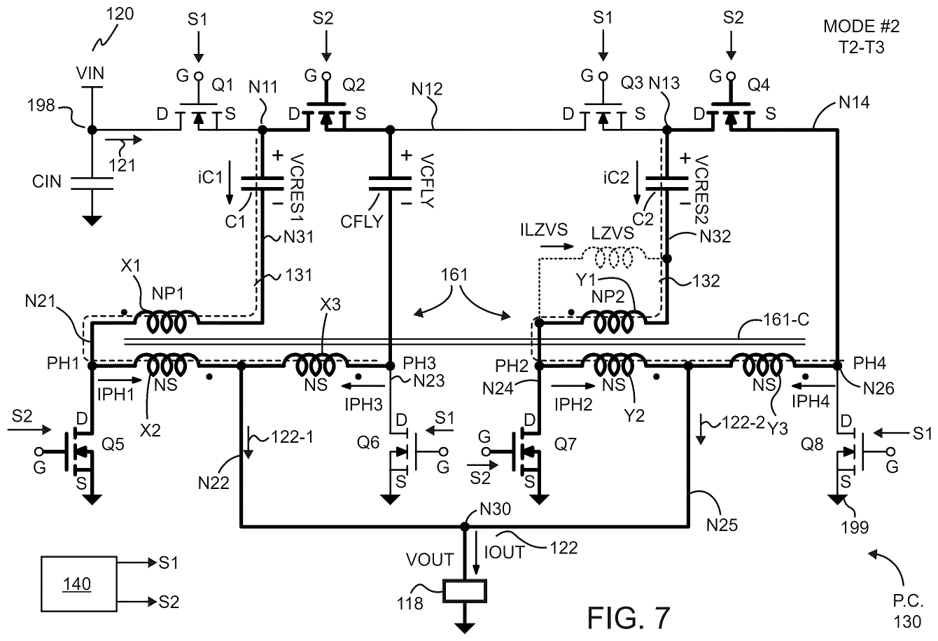

FIG. 7 is an example diagram illustrating operation of the hybrid switched capacitor power converter during a second mode as discussed herein.

During the mode #2 such as between time T2 and time T3, the controller 140 controls the switches Q1, Q3, Q6, and Q8 to an OFF-state. During the mode #2 such as between time T2 and time T3, the controller 140 controls the switches Q2, Q4, Q5, and Q7 to an ON-state via ZVS and in zero current switching (ZCS) and a resonant current iC1 takes place between capacitor C1 such as Cres1 and the leakage inductance Lzvs of the multi-tapped transformer 161, while another resonant current iC2 takes place between capacitor C2 such as Cres2 and the leakage inductance Lzvs of the transformer 161. In this phase, the capacitor C2 such as Cres2 is soft-discharged and capacitor C1 such as Cres1 is soft-discharged charging the capacitor Cfly.

By assuming i(Cres1)(t)= [symbol] −i [symbol] res(t)=i(Cres2) (t) (i.e. cells placed in series through flying capacitor Cfly), the output current can be calculated with the following equation:

$$iout ( t ) = iph 1 ( t ) + iph 3 ( t ) + iph 2 ( t ) + iph 4 ( t ) = [ 2 i 〛 ( res ( t ) ) + i ( res ( t ) ) ( 2 Np 1 / Ns + 2 ) + 〚 2 i 〛 ( res ( t ) ) + i ( res ( t ) ) ( 2 Np 1 / Ns + 2 ) = i ( res ( t ) ) ( 2 Np 1 / Ns + 2 Np 2 / Ns + 8 ) \qquad equation 6$$

During this phase the following equations are valid (i.e. in steady state):

$$VCres 1 - Vout Np 1 / Ns - 〚 2 V 〛 out - VCfly = 0 \qquad equation 7$$

$$VCres 2 - Vout Np 2 / Ns - 〚 2 V 〛 out = 0 \qquad equation 8$$

From Equation 7, it is possible to calculate the DC voltage across Cres2:

$$VCres 2 = Vout ( Np 2 / Ns + 2 ) \qquad equation 9$$

By combining equations, calculation of the DC voltage Vcres1 across C1 (resonant capacitor Cres1) is as follows:

$$eq . 10$$

$$VCres 1 = Vin ( ( 6 + Np 1 / Ns + 2 Np 2 / Ns ) / ( 8 + 2 Np 1 / Ns + 2 Np 2 / Ns ) )$$

By further combining equations above, calculation of the DC voltage Vcfly across capacitor Cfly is as follows:

$$VCfly = Vin ( ( 2 + Np 2 / Ns ) / ( 4 + Np 1 / Ns + Np 2 / Ns ) ) \qquad eq . 11$$

Accordingly, as discussed herein, the switch circuitry associated with the power converter 130 includes a first switch Q2 and a second switch Q3. The controller 140 switches between a first mode and a second mode of controlling the switches Q2 and Q3, where the first mode between time T0 and time T1 includes activation of the switch Q3 to an ON-state and deactivation of the switch Q2 to an OFF-state. The second mode includes activation of the switch Q2 to an ON-state and deactivation of the switch Q3 to an OFF-state. The activation of the switch Q3 in the first mode is operative to electrically connect the node N12 of the flying capacitor CFLY to the second circuit path 132; and the deactivation of the switch Q2 in the first mode is operative to electrically disconnect the first node N12 of the flying capacitor CFLY from the first circuit path 131.

Yet further, it is noted that activation of the switch Q2 in the second mode between time T2 and time T3 is operative to produce a first circuit loop including a loop circuit path including the first capacitor C1, the first windings (X1, X2, X3), and the flying capacitor CFLY in series; additionally, activation of the switch Q4 in the second mode produces a second circuit loop including a loop circuit path comprising the second capacitor C2 and the second windings (Y1, Y2, Y3) in series.

Yet further, as previously discussed, the power converter 130 includes switch Q5 directly coupled to a first tap node 21 (PH1) of the first windings X1, X2, X3; switch Q7 directly coupled to a first tap node N24 (PH2) of the second windings Y1, Y2, Y3.

The controller 140 switches between activation/deactivation of the switch Q5 and the switch Q7 during the first mode and the second mode. For example, as previously discussed, the first mode includes deactivation of the switch Q5 to an off state and deactivation of the switch Q7 to an off state; and the second mode includes activation of the switch Q5 to an on state and activation of the switch Q7 to an on state.

The first windings further include a second tap node N22; the second windings include a second tap node N25. The output node N30 of the power converter 130 receives receive first output current 122-1 outputted from the second tap node N22 of the first windings and a second output current 122-2 outputted from the second tap node N25 of the second windings.

In still further examples, the power converter 130 includes a first capacitor C1 disposed in series with the first windings in the first circuit path 131; the power converter 130 includes a second capacitor C2 disposed in series with the second windings in the second circuit path 132. The controller 140 is configured to control the switch circuitry Q1-Q8 in accordance with a first mode during which: i) current 121 from an input voltage source 120 or iC1 flows through the first circuit path 131 towards a ground reference voltage 199 (note that switch Q6 is on), creating output current 122-1 from node N22; and ii) current iC2 from the flying capacitor CFLY flows through switch Q3, the second circuit path 132, and switch Q8 towards a reference voltage 199, creating output current 122-2 from node N25.

In one example, the first flow of current iC1 is first resonant current through the first circuit path 131; the second flow of current iC2 is second resonant current through the second circuit path 132. The second flow of current iC2 through the second circuit path is operative to charge the flying capacitor CFLY.

Yet further, the controller 140 as discussed herein can be configured to control the switch circuitry such as switch Q2 and switch Q4 coupled to the first circuit path 131 and the second circuit path 132 in accordance with a second mode. The control of such switch circuitry in the second mode including activation of switch Q2 to an on state is operative to electrically connect the first capacitor C1, windings X1, X2, and X3, and the flying capacitor CFLY in series to create a first circuit loop including a combination of the first circuit path 131 and the flying capacitor CFLY. Additionally, the control of switch circuitry in the second mode includes activation of switch Q4 to an on state and is operative to electrically connect a node N13 of the second capacitor C2 to a node N14 of the second windings Y1, Y2, Y3 to create a second circuit loop including a series combination of the second circuit path 132 such that capacitor C2, windings Y1, Y2, and Y3, are connected in a series loop.

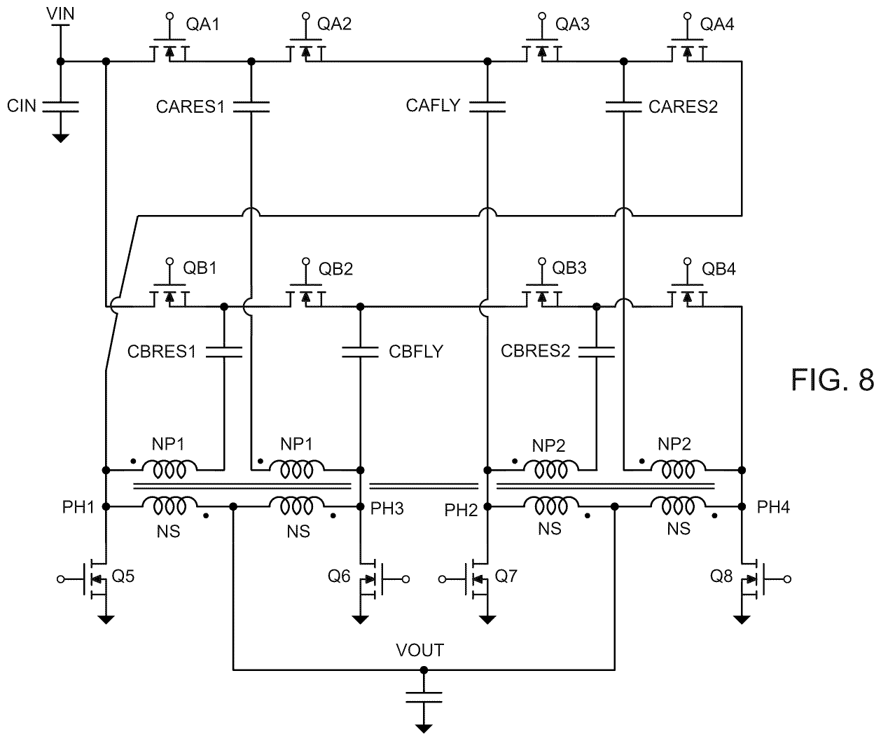

FIG. 8 is an example diagram illustrating a hybrid switched capacitor power converter as discussed herein.

In this example, the power converter 800 as shown in FIG. 8 receives energy from the input for only half cycle; indeed high ripple current can appear at the input. To overcome such limitation, the converter in FIG. 8 illustrates a dual-phase configuration. In a dual-phase configuration, the first row of switches (QA1, QA2, QA3 and QA4) and corresponding capacitors is complemented by adding one additional input stage, i.e. by adding a second row of switches (QB1, QB2, QB3 and QB4), corresponding capacitors (CBres1, CBfly and CBres2) and primary windings with NP1 and NP2 turns.

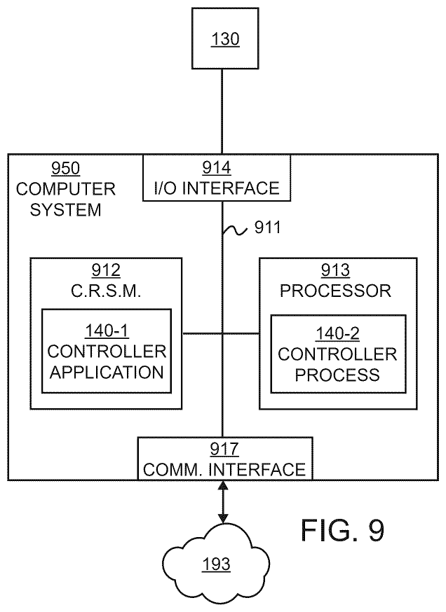

FIG. 9 is an example block diagram of a computer device for implementing any of the operations as discussed herein according to embodiments herein.

As shown, computer system 900 (such as implemented by any of one or more resources such as controller 140, etc.) of the present example includes an interconnect 911 that couples computer readable storage media 912 such as a non-transitory type of media (or hardware storage media) in which digital information can be stored and retrieved, a processor 913 (e.g., computer processor hardware such as one or more processor devices), I/O interface 914, and a communications interface 917. Accordingly, the controller application 140-1 and controller process 140-2 is a potential instantiation of the controller 140.

I/O interface 914 provides connectivity to any suitable circuitry such as one or more voltage converters.

Computer readable storage medium 912 can be any hardware storage resource or device such as memory, optical storage, hard drive, floppy disk, etc. In one embodiment, the computer readable storage medium 912 stores instructions and/or data used by the controller application 140-1 to perform any of the operations as described herein.

Further in this example embodiment, communications interface 917 enables the computer system 900 and processor 913 to communicate over a resource such as network 190 to retrieve information from remote sources and communicate with other computers.

As shown, computer readable storage media 912 is encoded with controller 140-1 (e.g., software, firmware, etc.) executed by processor 913. Controller application 140-1 can be configured to include instructions to implement any of the operations as discussed herein.

During operation of one embodiment, processor 913 accesses computer readable storage media 912 via the use of interconnect 911 in order to launch, run, execute, interpret or otherwise perform the instructions in controller application 140-1 stored on computer readable storage medium 912.

Execution of the controller application 140-1 produces processing functionality such as controller process 140-2 in processor 913. In other words, the controller process 140-2 associated with processor 913 represents one or more aspects of executing controller application 140-1 within or upon the processor 913 in the computer system 900.

In accordance with different embodiments, note that computer system 900 can be a micro-controller device, logic, hardware processor, hybrid analog/digital circuitry, etc., configured to control a power supply and perform any of the operations as described herein.

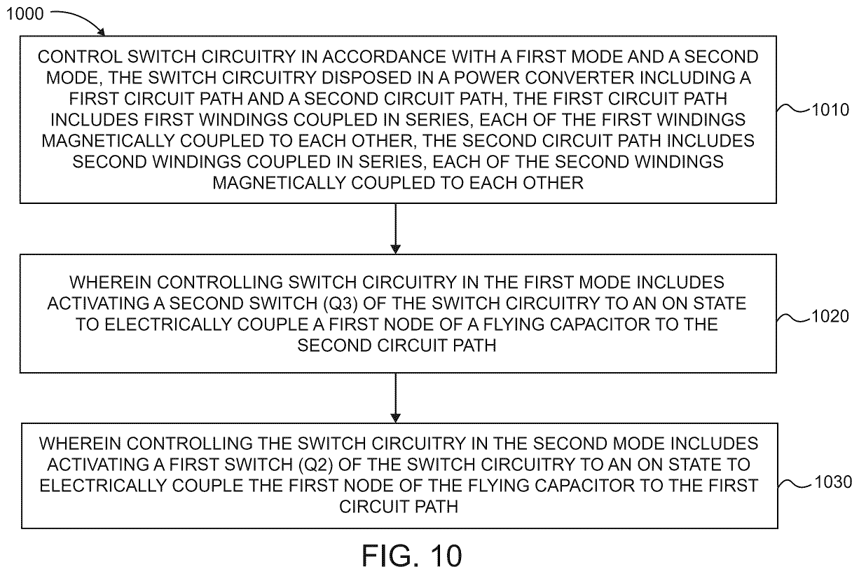

Functionality supported by the different resources will now be discussed via flowchart in FIG. 10. Note that the steps in the flowcharts below can be executed in any suitable order.

FIG. 10 is a flowchart 1000 illustrating an example method as discussed herein. Note that there will be some overlap with respect to concepts as discussed above.

In processing operation 1010, the controller 140 controls switch circuitry in accordance with a first mode and a second mode, the switch circuitry disposed in a power converter including a first circuit path and a second circuit path. In one example, as previously discussed, the first circuit path can be configured to include first windings coupled in series, each of the first windings magnetically coupled to each other. The second circuit path can be configured to include second windings coupled in series, each of the second windings magnetically coupled to each other.

In processing operation 1020, the controller 140 controls switch circuitry in the first mode (such as between time T0 and time T1 in a respective control cycle) by activating a switch Q3 of the switch circuitry to an on state to electrically couple a first node N12 of a flying capacitor Cfly to the second circuit path 132.

In processing operation 1030, the controller 140 controls the switch circuitry in the second mode (such as between time T2 and time T3) by activating a first switch (Q2) of the switch circuitry to an on state to electrically couple the first node N12 of the flying capacitor Cfly to the first circuit path 131.

Note again that techniques herein are well suited for use in power supply applications. However, it should be noted that the disclosure of matter herein is not limited to use in such applications and that the techniques discussed herein are well suited for other applications as well.

While this invention has been particularly shown and described with references to preferred aspects thereof, it will be understood by those skilled in the art that various changes in form and details may be made therein without departing from the spirit and scope of the present application as defined by the appended claims. Such variations are intended to be covered by the scope of this present application. As such, the foregoing description in the present disclosure is not intended to be limiting. Rather, any limitations to the invention are presented in the following claims.

1. An apparatus comprising:
a first circuit path including first windings coupled in series, each of the first windings magnetically coupled to each other;
a second circuit path including second windings coupled in series, each of the second windings magnetically coupled to each other; and
switch circuitry operative to selectively switch between electrically connecting a flying capacitor in series with the first circuit path and electrically connecting the flying capacitor in series with the second circuit path.

2. The apparatus as in claim 1 further comprising:
an output node operative to: i) receive a first output current from a first tap node of the first windings and a second output current from a second tap node of the second windings, and ii) output a combination of the first output current and the second output current from the output node to power a load.

3. The apparatus as in claim 1, wherein the first windings are disposed in a first autotransformer; and
wherein the second windings are disposed in a second autotransformer, the second autotransformer magnetically separated from the first autotransformer.

4. The apparatus as in claim 1 further comprising:
a first capacitor;
a second capacitor;
wherein the first circuit path is a first resonant circuit path including the first capacitor disposed in series with the first windings; and
wherein the second circuit path is a second resonant circuit path including the second capacitor disposed in series with the second windings.

5. The apparatus as in claim 1, wherein the switch circuitry includes a first switch and a second switch, the apparatus further comprising:
a controller operative to switch between a first mode and a second mode of controlling the first switch and the second switch;
wherein the first mode includes activation of the second switch to an ON-state and deactivation of the first switch to an OFF-state; and
wherein the second mode includes activation of the first switch to an ON-state and deactivation of the second switch to an OFF-state.

6. The apparatus as in claim 5, wherein the activation of the second switch in the first mode is operative to electrically connect a first node of the flying capacitor to the second circuit path; and
wherein the deactivation of the second switch in the first mode is operative to electrically disconnect the first node of the flying capacitor from the first circuit path.

7. The apparatus as in claim 6, wherein the first circuit path includes a first capacitor disposed in series with the first windings; and
wherein the second circuit path includes a second capacitor disposed in series with the second windings.

8. The apparatus as in claim 7, wherein the switch circuitry includes a third switch (Q4) directly coupled to the second switch (Q3);
wherein activation of the first switch (Q2) in the second mode is operative to produce a first circuit loop including the first capacitor, the first windings, and the flying capacitor in series; and
wherein activation of the third switch (Q4) in the second mode is operative to produce a second circuit loop including the second capacitor and the second windings in series.

9. The apparatus as in claim 8, wherein the first windings and the second windings are disposed in a multi-tapped autotransformer; and
wherein the first windings and the second windings are magnetically coupled to each other in the multi-tapped autotransformer.

10. The apparatus as in claim 1 further comprising:
first switch circuitry directly coupled to a first tap node of the first windings;
second switch circuitry directly coupled to a first tap node of the second windings;
a controller operative to switch between operation of the first switch circuitry and the second switch circuitry in a first mode and a second mode;
wherein the first mode includes deactivation of the first switch circuitry to an off state and deactivation of the second switch circuitry to an off state; and
wherein the second mode includes activation of the first switch circuitry to an on state and activation of the second switch circuitry to an on state.

11. The apparatus as in claim 10, wherein the first windings include a second tap node;
wherein the second windings include a second tap node; and
the apparatus further comprising an output node operative to receive first output current outputted from the second tap node of the first windings and a second output current outputted from the second tap node of the second windings.

12. The apparatus as in claim 1 further comprising:
a first capacitor disposed in series with the first windings in the first circuit path;
a second capacitor disposed in series with the second windings in the second circuit path; and
a controller operative to control the switch circuitry in accordance with a first mode, the control of the switch circuitry in the first mode operative to cause: i) a first flow of current from an input voltage source through the first circuit path to a reference voltage, and ii) a second flow of current through a combination of the flying capacitor and the second circuit path to the reference voltage.

13. The apparatus as in claim 12, wherein the first flow of current is first resonant current through the first circuit path; and
wherein the second flow of current is second resonant current through the second circuit path, the second flow of current through the second circuit path operative to charge the flying capacitor.

14. An apparatus comprising:
a first circuit path including a series combination of a first capacitor and first inductive windings, the first inductive windings operative to output a first output current;
a second circuit path including a series combination of a second capacitor and second inductive windings, the second inductive windings operative to output a second output current; and
a controller operative to control switch circuitry in a first mode and a second mode, the first mode including activation of a first switch (Q3) of the switch circuitry to an on state to electrically couple a first node of a flying capacitor to the second circuit path, the second mode including activation of a second switch (Q2) of the switch circuitry to an on state to electrically couple the first node of the flying capacitor to the first circuit path.

15. The apparatus as in claim 14, wherein the first inductive windings and the second inductive windings are inductively coupled to each other in a multi-tapped autotransformer.

16. The apparatus as in claim 14, wherein the first inductive windings are disposed in a first autotransformer; and
wherein the second inductive windings are disposed in a second autotransformer.

17. The apparatus as in claim 14, wherein the switch circuitry includes a third switch directly coupled to a second node of the flying capacitor;
wherein the controller is further operative to activate the third switch to an on state during the first mode; and
wherein the controller is further operative to deactivate the third switch to an off state during the second mode.

18. A method comprising:
controlling switch circuitry in accordance with a first mode and a second mode, the switch circuitry disposed in a power converter including a first circuit path and a second circuit path;
wherein the first circuit path includes first windings coupled in series, each of the first windings magnetically coupled to each other;
wherein the second circuit path includes second windings coupled in series, each of the second windings magnetically coupled to each other;
wherein controlling switch circuitry in the first mode includes activating a second switch (Q3) of the switch circuitry to an on state to electrically couple a first node of a flying capacitor to the second circuit path; and
wherein controlling the switch circuitry in the second mode includes activating a first switch (Q2) of the switch circuitry to an on state to electrically couple the first node of the flying capacitor to the first circuit path.

19. The apparatus as in claim 1, wherein the first windings include a first winding and a second winding;
wherein the first winding and the second winding are disposed in series in a first autotransformer winding path of an autotransformer;
wherein the second windings include a third winding and a fourth winding;
wherein the third winding and the fourth winding are disposed in series in a second autotransformer winding path of the autotransformer; and
wherein the first windings and the second windings are magnetically coupled to each other.

20. The apparatus as in claim 12, wherein the controller is further operative to control the switch circuitry coupled to the first circuit path and the second circuit path in accordance with a second mode, the control of the switch circuitry in the second mode operative to: i) electrically connect the first capacitor and the flying capacitor in series to create a first circuit loop including a combination of the first circuit path and the flying capacitor, and ii) electrically connect a node of the second capacitor to a node of the second windings to create a second circuit loop.
